(19) United States
(12) Patent Application Publication
(10) Pub. No.: US 2011/0280649 A1
(43) Pub. Date: Nov. 17, 2011

(54) CONSTRUCTION JOINTS AND RELATED CONNECTORS

(75) Inventors: William Dewson, Toronto (CA); David Bowick, Scarborough (CA)

(73) Assignee: WILLIAM DEWSON ARCHITECTS INC., Toronto (CA)

(21) Appl. No.: 12/777,498

(22) Filed: May 11, 2010

(51) Int. Cl. F16B 9/00

(52) U.S. Cl. 403/171

(57) ABSTRACT

A connector for use in a construction joint including a first plate having respective first and second ends, and a first slit extending from the first end to a predetermined depth on the first plate, and a second plate having respective first and second ends, and a second slit extending from the second end of the second plate to a predetermined depth on the second plate. When assembled, the first and second plates intersect through the first and second slits such that the connector has a cross-section that is, at least in part, generally cruciform-shaped. The connector may also include a bearing plate. The first plate further includes a bearing plate slit formed between an end of the first slit and the second end of the first plate, and extending generally perpendicular to the first slit, such that the bearing plate slit is adapted to receive the bearing plate. The bearing plate is positioned such that the second end of the second plate abuts against the bearing plate when assembled.

### FIELD OF THE INVENTION

The present invention relates to the field of construction joints, and more specifically to a modular construction joint and method of assembly thereof.

### BACKGROUND OF THE INVENTION

Construction joints and connectors for connecting between two and six orthogonal structural members are widely known and used in the prior art. Prior art connectors and joint constructions have often included specially formed connectors occupying large transport space, and relatively complex field operations in either assembling the joints or modifying the structural members in the field prior to forming the joints. These operations can be time consuming and require a degree of expertise and workmanship at a construction site. Furthermore, prior art connectors are often visible between connected structural members and use of any space between the structural members is limited or hindered in some fashion.

Various attempts at resolving some of the aforementioned deficiencies have been attempted, one of which is disclosed in U.S. Pat. No. 4,863,305 to Schold, wherein an orthogonal construction joint is disclosed to interconnect two or more beams and one or two posts. As is evident from FIGS. 2 and 3 of Schold, the beams and posts require significant modification and complex shapes in order to work the Schold connector. Furthermore, Schold relies on angled bolts or screws to provide resistance to moment and torsion loads and affix the beams to the connector. Complex machining and modification of the beams as is required by Schold. Furthermore, the Schold connector is not readily adaptable to different configurations and more complex joint types as is often required in structural frame constructions.

Various other construction joints require significant tooling costs in manufacturing the connectors or rely on field workmanship of construction personnel to ensure a proper joint is formed. It is an object of this invention to partially or completely fulfill one or more of the above-mentioned needs.

### SUMMARY OF THE INVENTION

The invention in a preferred embodiment described herein comprises a connector for use in a construction joint including a first plate having respective first and second ends, and a first slit extending from the first end to a predetermined depth on the first plate, and a second plate having respective first and second ends, and a second slit extending from the second end of the second plate to a predetermined depth on the second plate. The first and second plates intersecting through the first and second slits such that the connector has a cross-section that is, at least in part, generally cruciform-shaped.

According to one aspect of the preferred embodiment, the first plate further includes a bearing plate slit formed between an end of the first slit and the second end of the first plate, and extending generally perpendicular to the first slit; the bearing plate slit adapted to receive a bearing plate therein. The bearing plate is positioned such that the second end of the second plate abuts against the bearing plate.

According to another embodiment of the invention, the first plate further includes a first projecting member extending from a first side of the first plate and a second projecting member extending form a second side of the first plate.

According to another embodiment of the invention, the bearing plate includes a slit adapted to interact with the bearing plate slit on the first plate.

According to a further embodiment of the invention, there is provided a second bearing plate. In this embodiment, the second plate further includes a second bearing plate slit formed between an end of the second slit and the first end of the second plate, and extending generally perpendicular to the second slit; the second bearing plate slit receiving the second bearing plate therein. The second bearing plate is positioned such that the first end of the first plate abuts against the second bearing plate.

According to one aspect of the invention, an ear plate is provided and functionally attached to one of the first projecting member and the second projecting member and a portion of the first plate proximate the first slit. Preferably, the bearing plate includes a first bearing plate portion and a second bearing plate portion; the first bearing plate slit including two portions extending in part from opposite ends of the first plate to receive therein the first bearing plate portion and the second bearing plate portion, respectively.

According to another aspect of the invention, the first projecting member further includes one of a male or female flitch portion adapted to connect to an adjacent and complimentary flitch portion on a projecting member on an adjacent connector.

According to another embodiment of the invention, there is provided a method for forming a construction joint including providing a first plate having respective first and second ends, and a first slit extending from the first end to a predetermined depth on the first plate; providing a second plate having respective first and second ends, and a second slit extending from the second end of the second plate to a predetermined depth on the second plate; and positioning the first and second plates such that the first and second slits intersect, thereby resulting in a cross-section that is, at least in part, generally cruciform-shaped.

According to one aspect of this embodiment, the first plate further includes a bearing plate slit formed between an end of the first slit and the second end of the first plate, and extending generally perpendicular to the first slit; and the method further includes providing a bearing plate and positioning the bearing plate to be received by the bearing plate slit, wherein the bearing plate is positioned such that the second end of the second plate abuts against the bearing plate.

According to another aspect of this embodiment, the second plate further includes a second bearing plate slit formed between an end of the second slit and the first end of the second plate, and extending generally perpendicular to the second slit; the method further including providing a second bearing plate and positioning the second bearing plate to be received by the second bearing plate slit, wherein the second bearing plate is positioned such that the first end of the first plate abuts against the second bearing plate.

According to another embodiment of the invention, there is disclosed a kit for forming connectors for use in constructions joints including at least one first plate having respective first and second ends, and a first slit extending from said first end to a predetermined depth on the first plate, the first plate further including a bearing plate slit formed between an end of the first slit and the second end of said first plate, and extending generally perpendicular to the first slit. The kit further includes at least one second plate having respective first and second ends, and a second slit extending from the second end of the second plate to a predetermined depth on the second plate; and, at least one bearing plate having a bearing plate slit. Numerous other optional elements of the kit are also disclosed.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The invention will now be described in more detail, by way of example only, with reference to the accompanying drawings, in which like numbers refer to like elements, wherein:

FIG. 1 is a perspective view of a frame construction employing various connectors and joints according to the present invention;

FIG. 2A is a top plan view of the various plates forming a connector according to one embodiment of the invention;

FIG. 2B is a perspective view of the assembled connector of FIG. 2A;

FIG. 2C is an exploded view of the connector of FIG. 2B;

FIG. 3A is a top plan view of the various plates forming a connector according to a second embodiment of the invention;

FIG. 3B is a perspective view of the assembled connector of FIG. 3A;

FIG. 3c is an exploded view of the connector of FIG. 3B;

FIG. 4a is a top plan view of the various plates forming a connector according to a third embodiment of the invention;

FIG. 4b is a perspective view of the assembled connector of FIG. 4a;

FIG. 4c is an exploded view of the connector of FIG. 4b;

FIG. 5a is a top plan view of the various plates forming a connector according to a fourth embodiment of the invention;

FIG. 5b is a perspective view of the assembled connector of FIG. 5a;

FIG. 5c is an exploded view of the connector of FIG. 5b;

FIG. 6a is a top plan view of the various plates forming a connector according to a fifth embodiment of the invention;

FIG. 6b is a perspective view of the assembled connector of FIG. 6a;

FIG. 6c is an exploded view of the connector of FIG. 6b;

FIG. 7a is a top plan view of the various plates forming a connector according to a sixth embodiment of the invention;

FIG. 7b is a perspective view of the assembled connector of FIG. 7a;

FIG. 7c is an exploded view of the connector of FIG. 7b;

FIG. 8a is a top plan view of the various plates forming a connector according to a seventh embodiment of the invention;

FIG. 8b is a perspective view of the assembled connector of FIG. 8a;

FIG. 8c is an exploded view of the connector of FIG. 8b;

FIG. 9a is a top plan view of the various plates forming a connector according to an eight embodiment of the invention;

FIG. 9b is a perspective view of the assembled connector of FIG. 9a;

FIG. 9c is an exploded view of the connector of FIG. 9b;

FIG. 10a is a top plan view of the various plates forming a connector according to a ninth embodiment of the invention;

FIG. 10b is a perspective view of the assembled connector of FIG. 10a;

FIG. 10c is an exploded view of the connector of FIG. 10b;

FIG. 11a is a top plan view of the various plates forming a connector according to a tenth embodiment of the invention;

FIG. 11b is a perspective view of the assembled connector of FIG. 11a;

FIG. 11c is an exploded view of the connector of FIG. 11b; and,

FIG. 12 is a top plan view of a kit for forming connectors according to the invention.

### DETAILED DESCRIPTION OF THE PREFERRED EMBODIMENTS

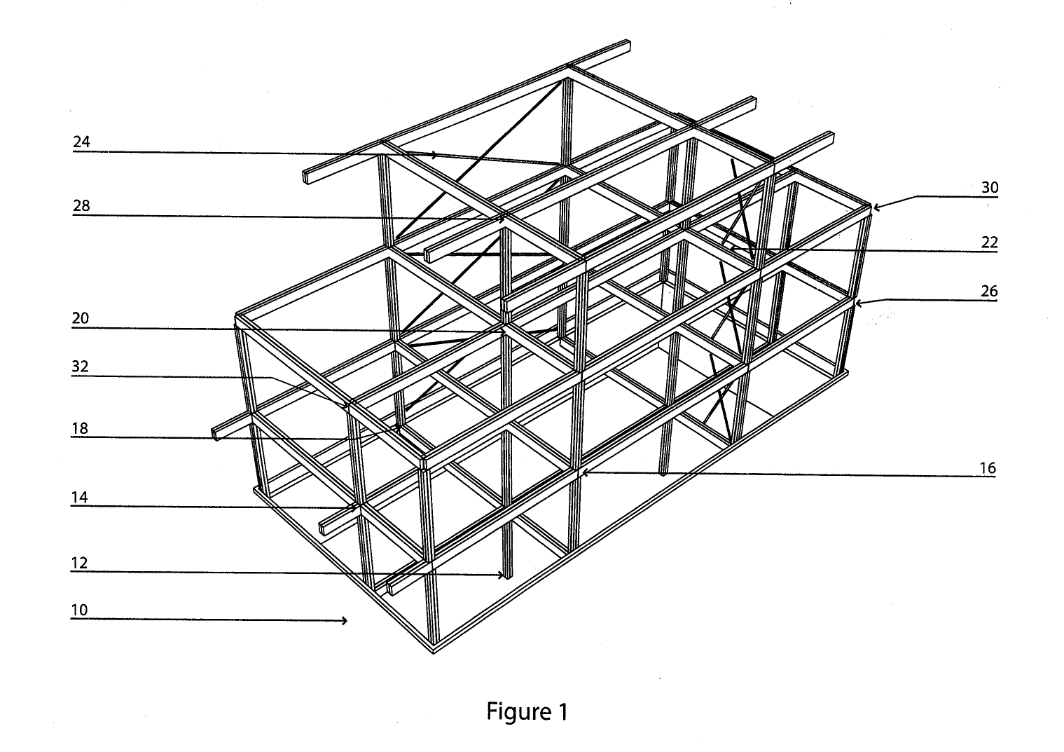

Referring now to FIG. 1, there is shown a representative frame construction 10 within which the construction joints and connectors of the present invention are preferably used. It will be understood by those skilled in the art that while the present invention is herein described with reference to the representative frame construction, the invention is not limited to use in such a frame construction. Rather, the invention is applicable for use in any construction joint, frame, structure, or any other use as would be apparent to one skilled in the art.

The invention is typically applied to various joints as would be found in the frame construction 10, including a footing joint 12, a cantilever joint 14, an edge joint 16, a foundation joint 18, a center joint 20 and a midpoint joint 22. Cross bracing 24 may also be used to provide additional strength in the structure. Additional joints in the structure that are variations of these include a corner joint 26, a center top joint 28, a corner top joint 30, and an edge top joint 32. The general purpose of each of these positions of joints is typically know in the art and therefore not further discussed. The present invention is directed at a system for forming these joints to facilitate construction, assembly and transportation, among other factors and at a system for providing modular joint construction for ease of design and field implementation. Various other benefits and advantages will become apparent to a person skilled in the art in view of the description.

In general, the joints of the invention are formed from a connector according to the invention and one or more structural members as described in further detail below. The structural members are preferably formed from wood and include beams, posts, and other structural elements as typically used in the frame structure of FIG. 1. For the purposes of the description below, various frame structural members are referred to as beams, posts, and structural elements as best exemplified in the particular embodiment being described, however, for functional purposes, these terms may be used interchangeably.

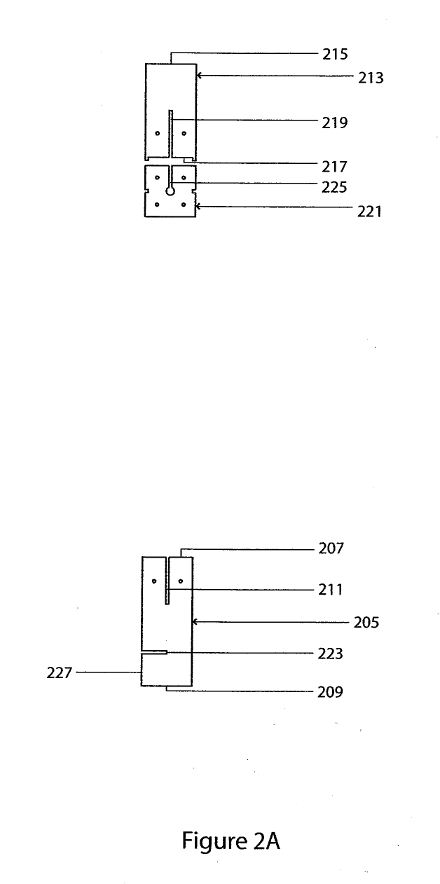

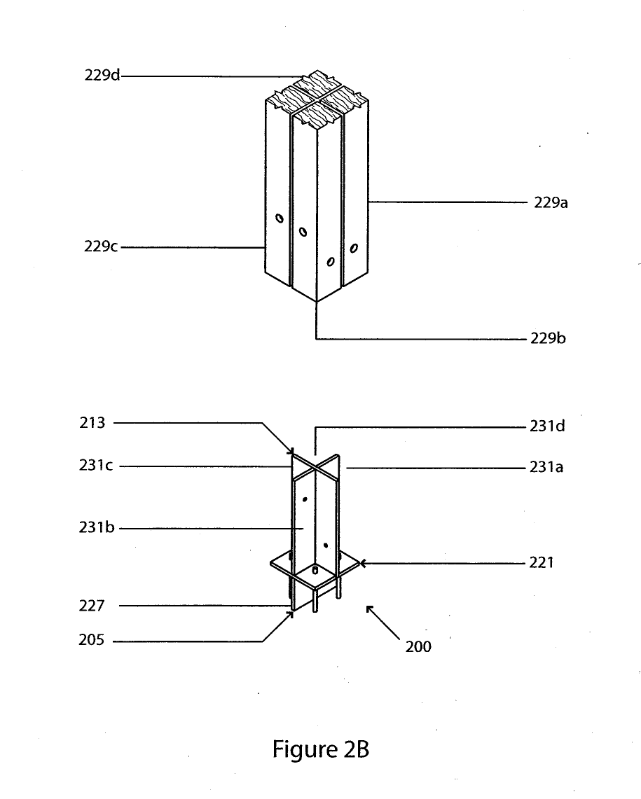

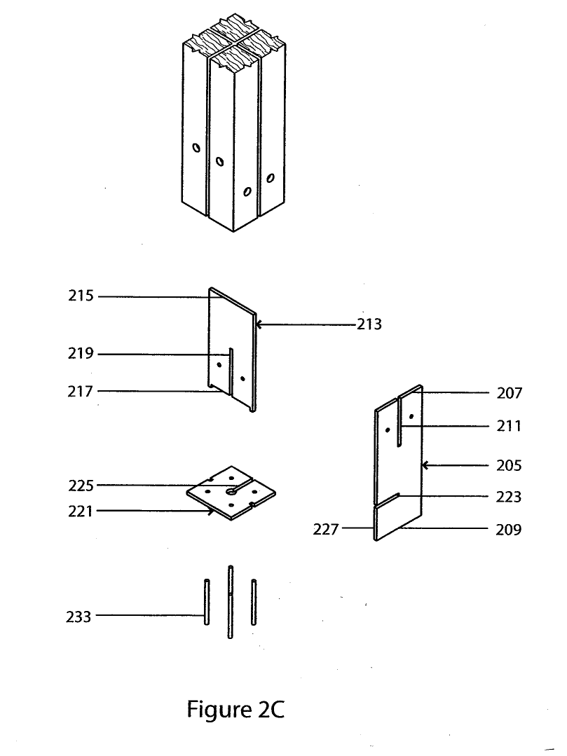

Referring now to FIG. 2A, there is a shown a representative connector 200, as would be used, for example in a footing joint 14 in FIG. 1. The connector 200 generally includes a first plate 205 having respective first 207 and second 209 ends, and a first slit 211 extending from the first end 207 to a predetermined depth on the first plate 205. A second plate 213 is also provided having respective first 215 and second 217 ends, and a second slit 219 extending from the second end 217 of the second plate 213 to a predetermined depth on the second plate 213. The predetermined depth is determined, in part by, the size of the plates used in particular implementations of the invention, and would be readily determinable by a person skilled in the art.

When assembled into the connector 200 as shown in FIG. 2B, the first 205 and second 213 plates intersect through the first 211 and second 219 slits such that the connector 200 has a cross-section that is, at least in part, generally cruciform-shaped. FIG. 2C shows an exploded assembly view for further reference in showing an exemplary installation of the connector 200.

The connector 200 preferably further includes a bearing plate 221. When the bearing plate is included, the first plate 205 further includes a bearing plate slit 223 formed between an end of the first slit 211 and the second end of the first plate 209. The bearing plate slit 223 extends generally perpendicular to the first slit 211 and is arranged to receive the bearing plate 221 therein, preferably via slit 225 on the bearing plate 221. As assembled, and shown in FIG. 2B, the bearing plate 221 is positioned such that the second end 217 of the second plate 213 abuts against the bearing plate. The bearing plate 221 is preferably sized and otherwise dimensioned to be of a generally rectangular shape designed to support a portion of one side of a structural member, as will become clearer in view of the description below.

In use, the footing joint 12 is positioned such that the portion 227 below the bearing plate 221 rests in an undersurface, such as concrete. Preferably, four wood beams 229a, 229b, 229c, 229d are positioned in each quadrant 231a, 231b, 231c, 231d of the top portion 231 of the connector, and secured thereto by joining means, such as screws or bolts, or like components 233 as would be known to a person skilled in the art. The bottom surface of each of the beams will come to rest on a top surface of the bearing plate 221. Thus, the bearing plate 221 supports the beams 229a-d, and the cruciform-shaped cross-section of the upper portion of the connector provides a resistance to moment and/or torsion loads applied to the joint.

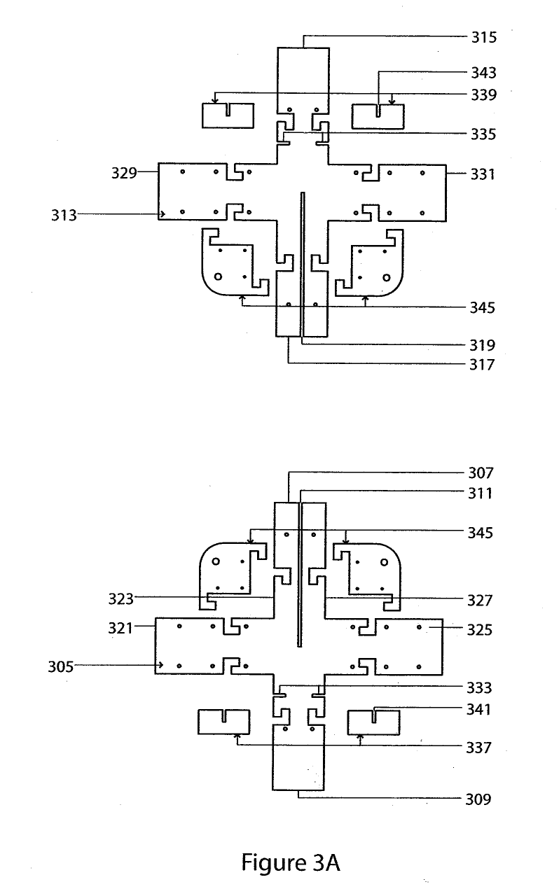

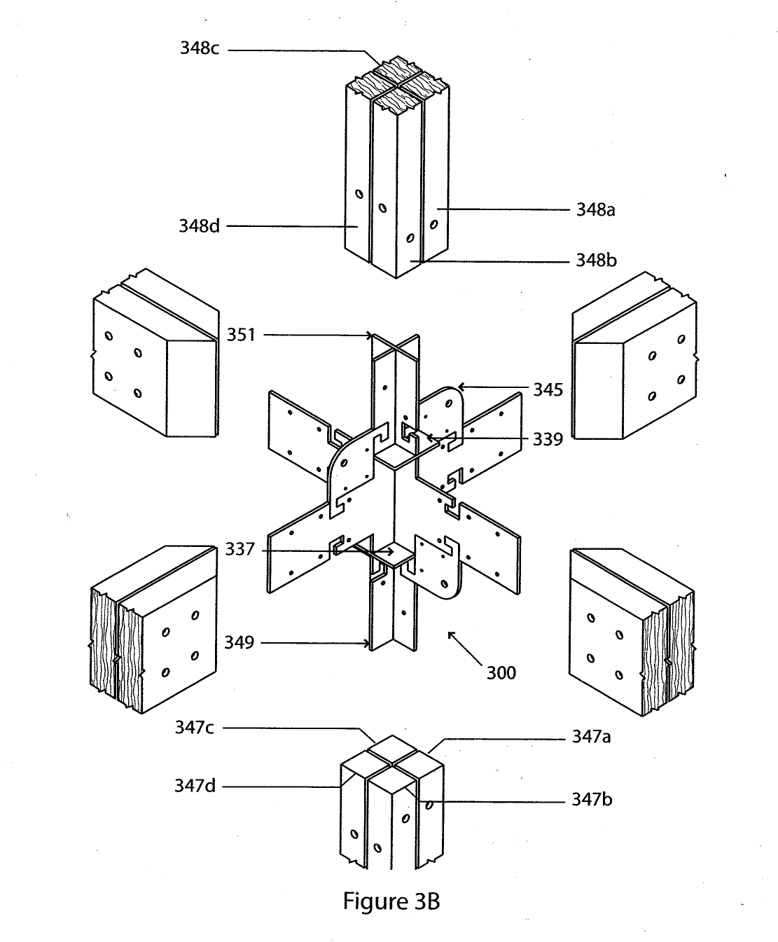

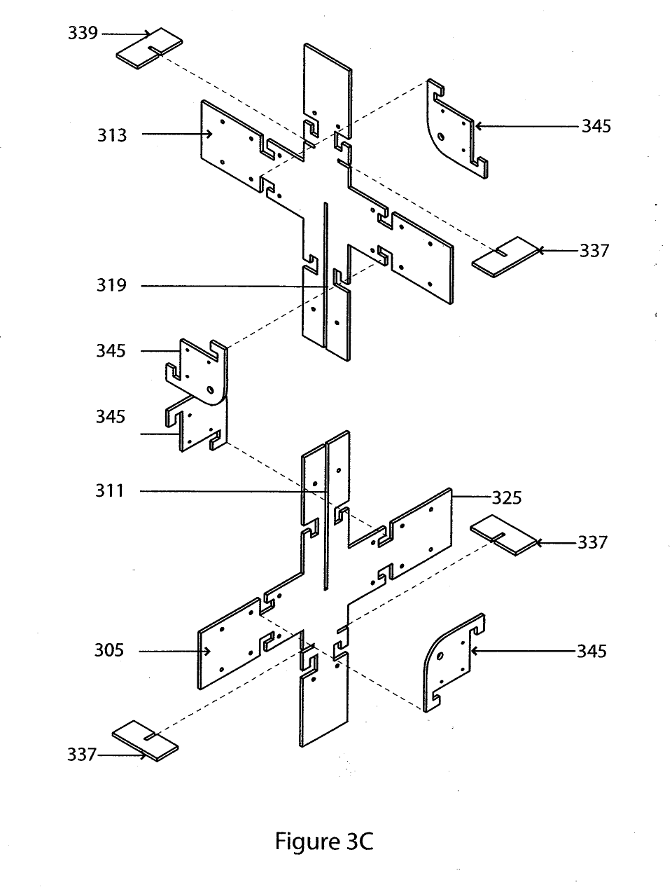

Referring now to FIGS. 3A, 3B and 3C, there is shown a representative center connector 300 as would be used in a center joint 20 of the frame construction of FIG. 1. The connector 300 generally includes a first plate 305 having respective first 307 and second 309 ends, and a first slit 311 extending from the first end 307 to a predetermined depth on the first plate 305. A second plate 313 is also provided having respective first 315 and second 317 ends, and a second slit 319 extending from the second end 317 of the second plate 313 to a predetermined depth on the second plate 313. For implementation at the center joint 20, the connector 300 further includes a first projecting member 321 extending from a first side 323 of the first plate 305 and a second projecting member 325 extending from a second side 327 of the first plate 305.

Similarly, the second plate 313 includes a first projecting member 329 and a second projecting member 331 extending from opposite sides of the second plate 313. Both the first plate 305 and the second plate 313 include bearing plate slits 333 and 335 respectively, that may be formed from one side of the plate 305 or 313, or from both sides as shown in FIG. 3A. According to the preferred embodiment, the bearing plate slits 333 and 335 are shaped and otherwise dimensioned to receive bearing plate portions 337 and 339 therein. As illustrated, bearing plate portions 337 and 339 each include receiving slits 341 and 343 and are adapted to interact with the bearing plate slits 333 and 335, respectively such that the bearing plates 337 and 339 form a surface upon which the ends of the first and second plates 305 and 313 abut when the connector is assembled, as shown in FIGS. 3B and 3C.

Optionally, the first plate 305 of connector 300 may further include ear plates 345 functionally attached on one end to one of the first projecting member 321 and the second projecting member 325 and on another end to a portion of the first plate proximate the first slit 311. In the preferred embodiment, the ear plates 345 include four sides, with attachment means on two adjacent sides, for attaching to a plate at a corner portion thereof, between one of the projecting members and of a main body portion of the plate. Similarly, the second plate 313 may also include ear plates 345 arranged in a similar manner on the second plate 313. The ear plates 345 are adapted to accommodate the inclusion of cross bracing 24, shown in FIG. 1. As will be appreciated by one skilled in the art, various screw, bolt or similar connector holes may be provided in any of the ear plates, bearing plates, first plate, or the second plate to facilitate this connection.

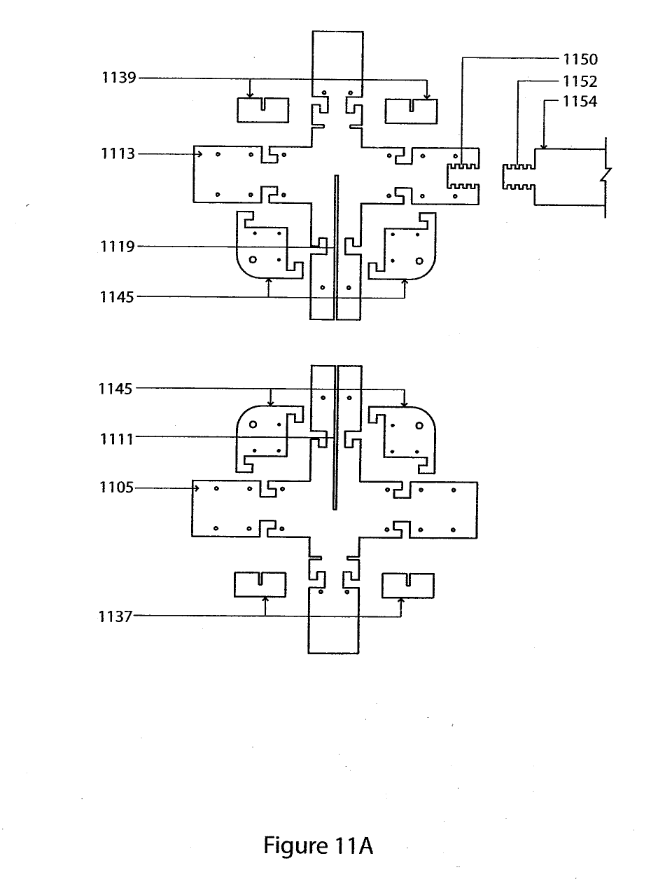

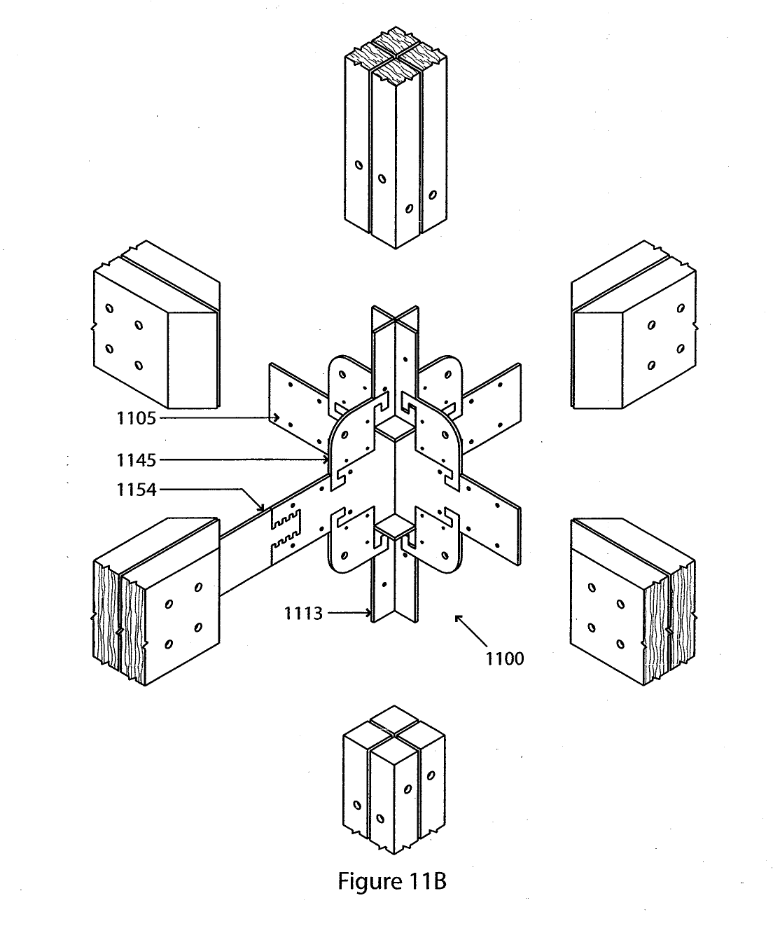

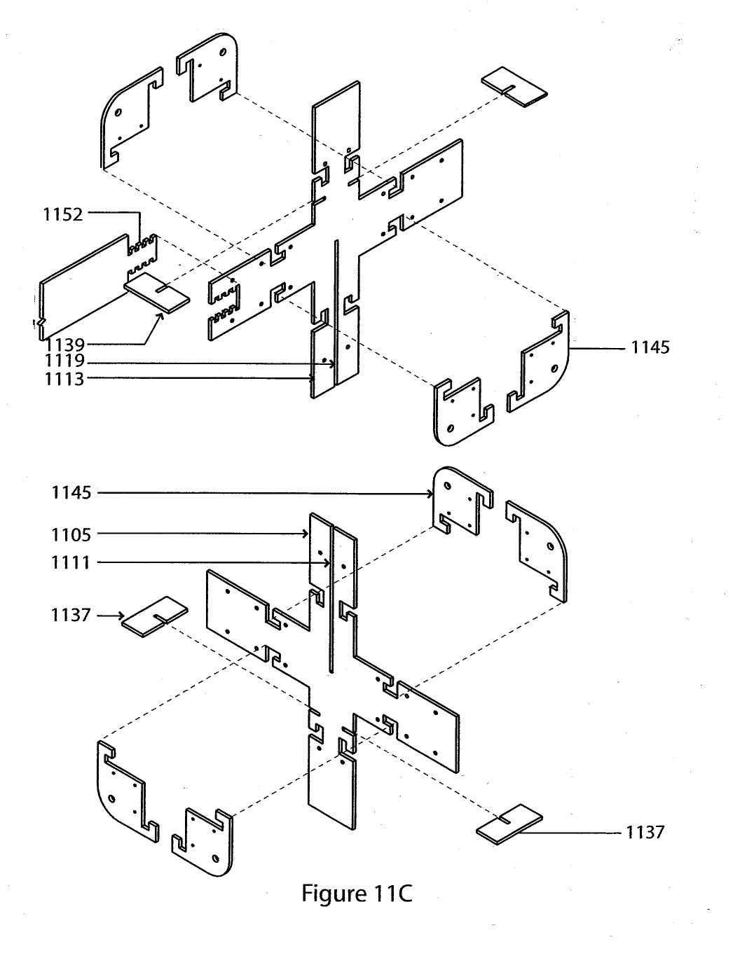

In use, the connector 300 forms a joint connecting frame structural members in six directions, as shown in FIG. 3B. For example, vertical frame members 347 and 348 may be formed from four partial beams, 347a-d and 384a-d that come to rest on bearing plates 337 and 345, respectively. Extending from the bearing plates 337 and 345 are portions of the first 305 and second 313 plates that when assembled, form the cruciform-shaped cross-sections 349 and 351. The partial beams 348a-d are each positioned in one of the quadrants of the cruciform-shaped cross-section, as shown. Screw, bolt, or similar fasteners are then installed to attach the partial beams 348a-d to the respective portion of the quadrant of the connector 300. In an alternative embodiment, not illustrated, rather that using four partial beams, a single beam with a cruciform-shaped kerf may be used, where the kerf is sized and dimensioned to receive the cruciform-shaped cross-section of the connector.

Where a flitch-type joint and connector is required, as shown in FIG. 11, a second plate 1113 incorporating all the elements of the second plate 313 described above, but further including a female connecting portion 1150 for attachment to a neighboring male connecting portion 1150 of an adjacent flitch member 1154. Other elements of the flitch-type joint and connector are not further described as they correspond with that shown in FIG. 3. For reference, like elements are correspondingly numbered in the 1100 series as in the 300 series of FIG. 3. For example, ear plates 1145 are substantially similar to ear plates 345 and are not further described.

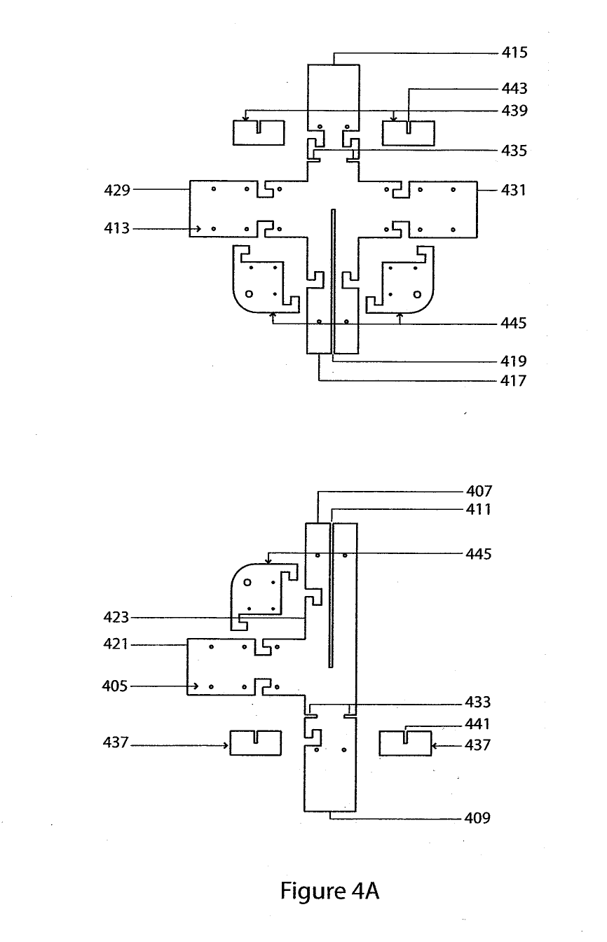

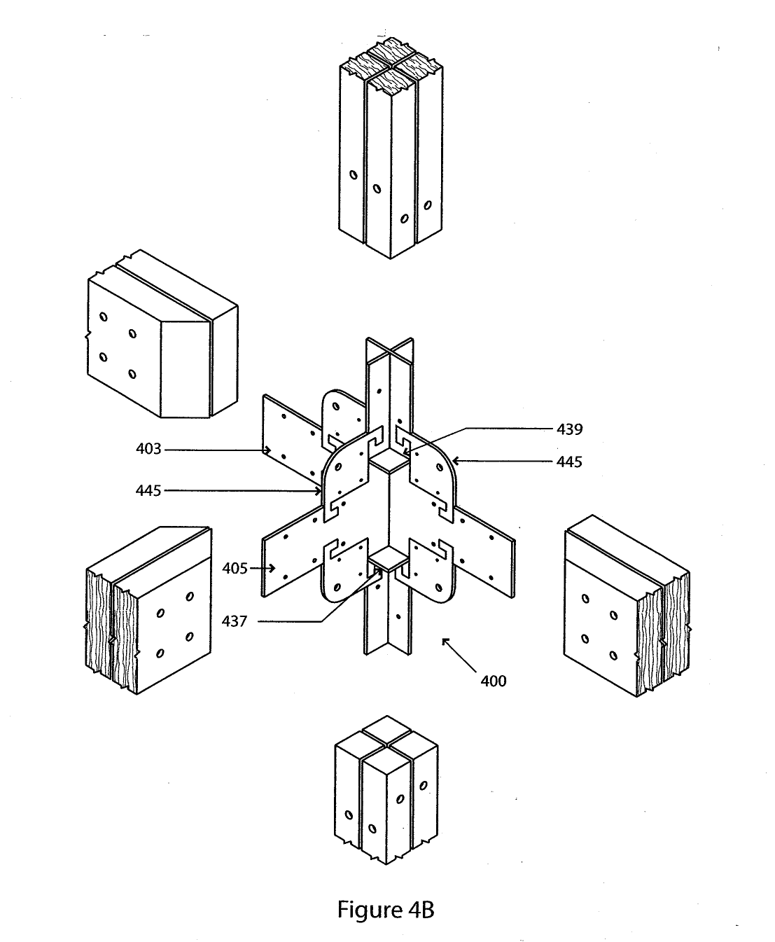

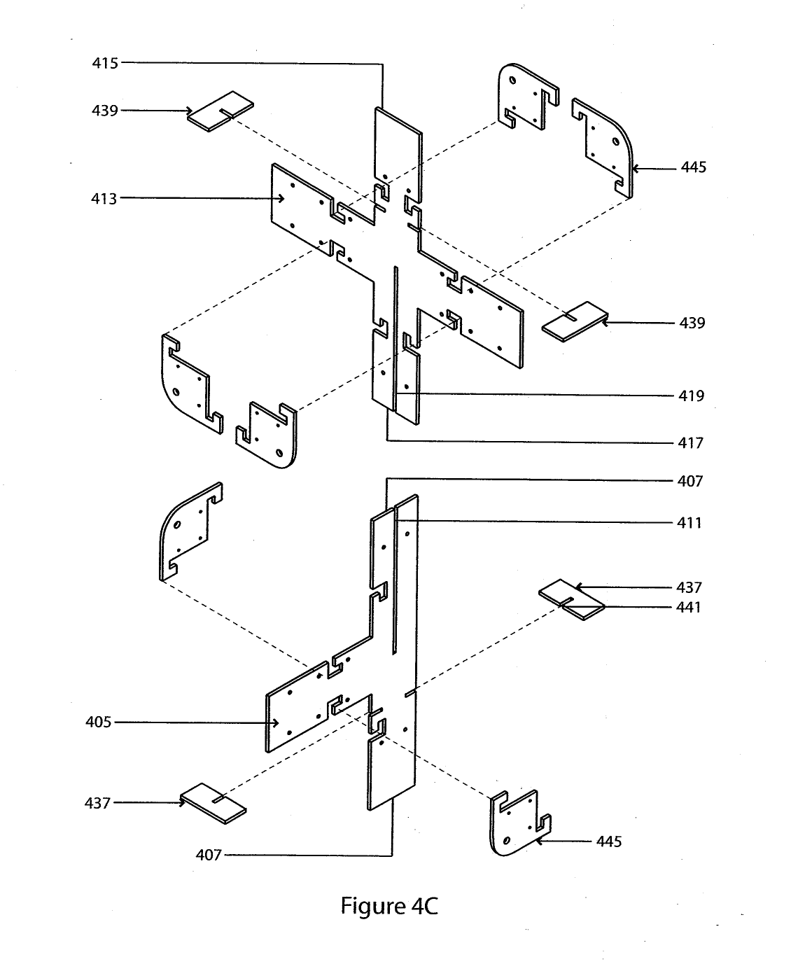

Referring now to FIGS. 4A, 4B and 4C, there is shown a representative edge connector 400 as would be used in an edge joint 16, shown in FIG. 1. Connector 400 includes a first plate 405 and a second plate 413 substantially similar to the second plate 313 of the center connector 300 shown in FIGS. 3A and 3B. Accordingly, the second plate 413 is not described in detail, and reference is to be had to the above description of the second plate 313 of the connector 300, where like elements are numbered in a corresponding manner, but in the 400 series. First plate 405 preferably includes respective first 407 and second 409 ends, and a first slit 411 extending from the first end 407 to a predetermined depth on the first plate 405. A first projecting member 421 extending from a first side 423 of the first plate 405 is also provided. Ear plates 445 are also optionally provided, as previously described with respect to ear plate 345.

In use, the connector 400 forms a joint connecting frame structural members in five directions, as shown in FIG. 4B. The manner of connection and arrangement of wood beams corresponds to that as has been previously described with respect to the connector 300, and is not further described with respect to this embodiment. FIG. 4C illustrates the manner of assembly and connection where like elements are numbered in the 400 series as have been numbered in the 300 series of FIG. 3.

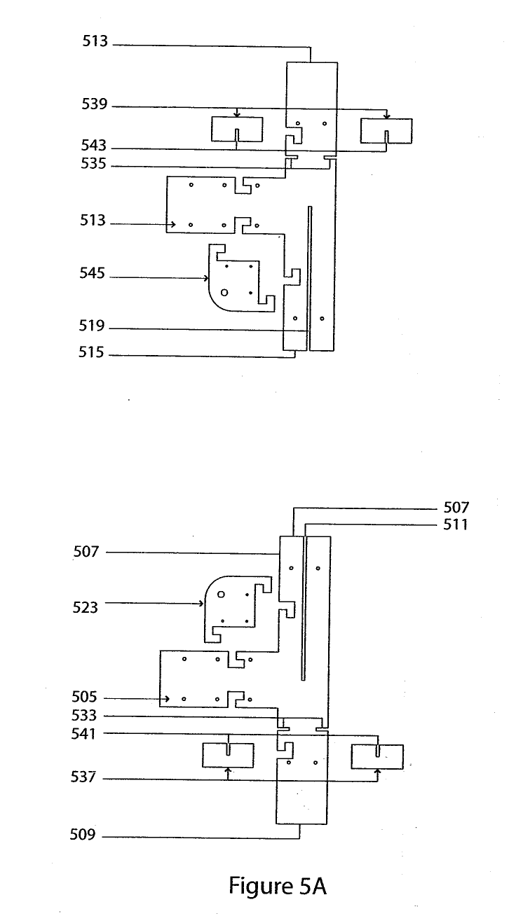

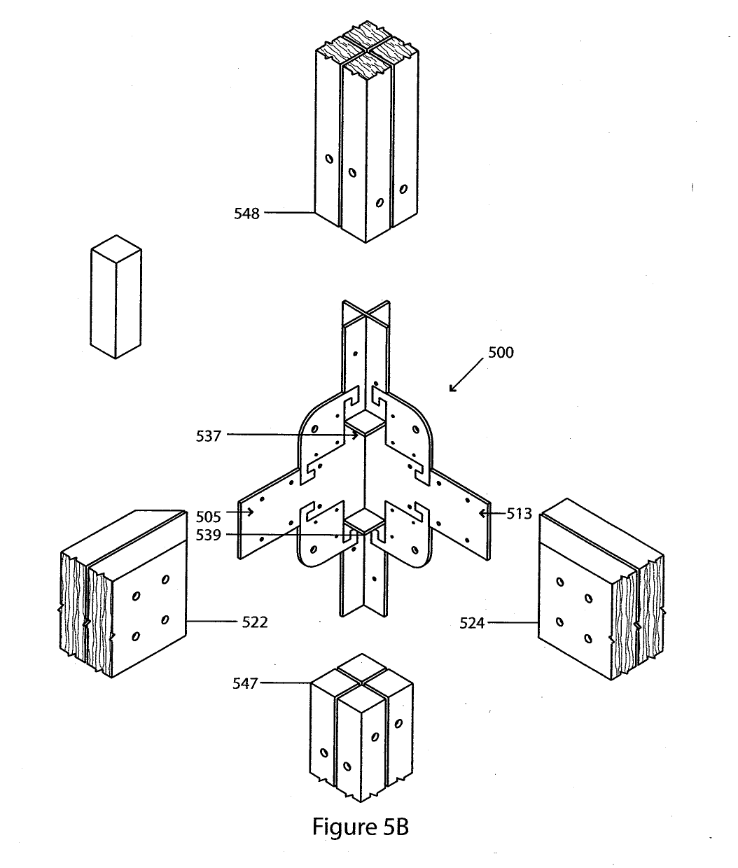

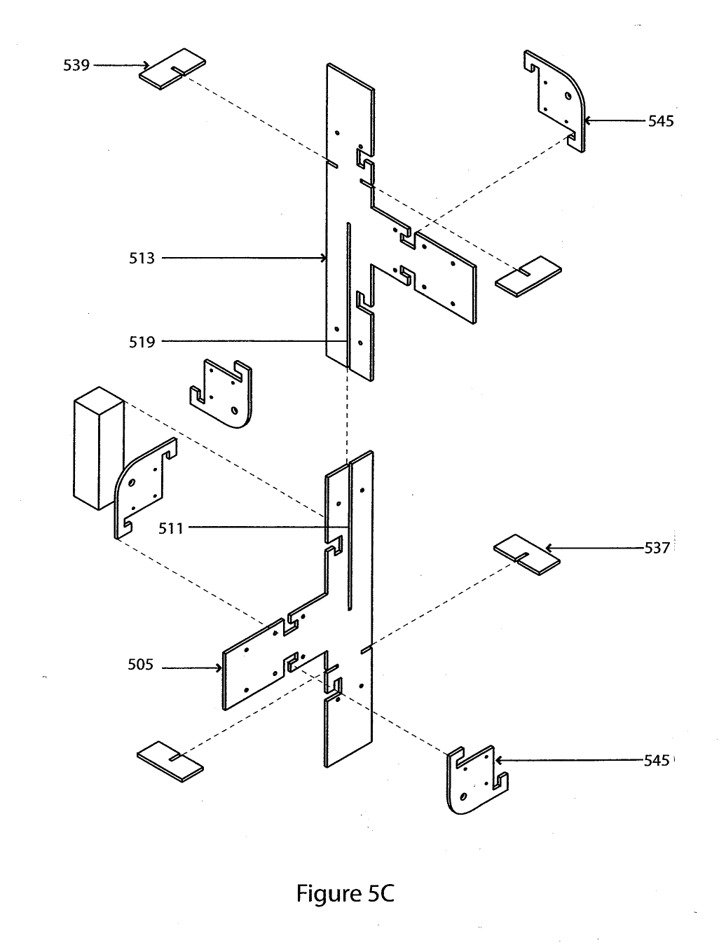

Referring now to FIGS. 5A, 5B and 5C, there is shown another embodiment of the invention as used in a corner joint 26 of FIG. 1. The corner connector 500 is formed from a first plate 505 and a second plate 513 formed in a substantially similar manner to the first plate 405 of the edge connector 400 shown in FIG. 4. As will be apparent from the above disclosure in relation to the previously described embodiments, when the connector 500 is assembled such that slit 507 interacts with slit 515, the cross-section of the connector 500 is in part cruciform-shaped, as shown in FIG. 5B. Extensions from the elemental cruciform-shaped cross-section are also provided as attachment surfaces for beams 522 and 524, for example. Post beams 547 and 548, formed from four partial beams as described above, are sized and dimensioned to attach to each quadrant in the cruciform shaped cross-section, as shown in FIG. 5B. Various other features, such as ear plates and fasteners as have been described in previous embodiments are equally applicable here. Bearing plates 537 and 539 are provided as have been described in the previous embodiments, forming a surface on which the post beams 547 and 548 are supported.

As will now be apparent to one skilled in the art, the invention includes various shaped first and second plates that, when assembled, form, a connector having, at least in part, a generally cruciform-shaped cross-section. The cruciform-shaped cross-section is adapted to provide an attachment surface for a post beam formed generally from four beam portions, each of which abuts and is otherwise connected to the interior surface of one of the quadrants in the cruciform-shaped cross-section. Bearing plates are preferably provided to be structurally integral with the connector, and connected via the slots shown and described in the various embodiments. The fully assembled structure of each of the connectors forms separate quadrants in which a series of orthogonal post or beam members can be fully supported. The invention provides the additional advantage that each of the joints is formed from modular components that are easy to transport and may be assembled on site. Below follows general description of various other implementations of the invention, with reference to positions of particular joints in FIG. 1. Only those elements that differ from previous embodiments are generally described. Elements that are not described in detail correspond to those described with respect to any one of FIGS. 2-5 and reference is made to the corresponding portions of the description above. Generally, in the figures, corresponding elements are numbered in like fashion according to the figure in which they are used and it will be understood that where an element is not described in detail, it is substantially similar to the corresponding element as has been previously described.

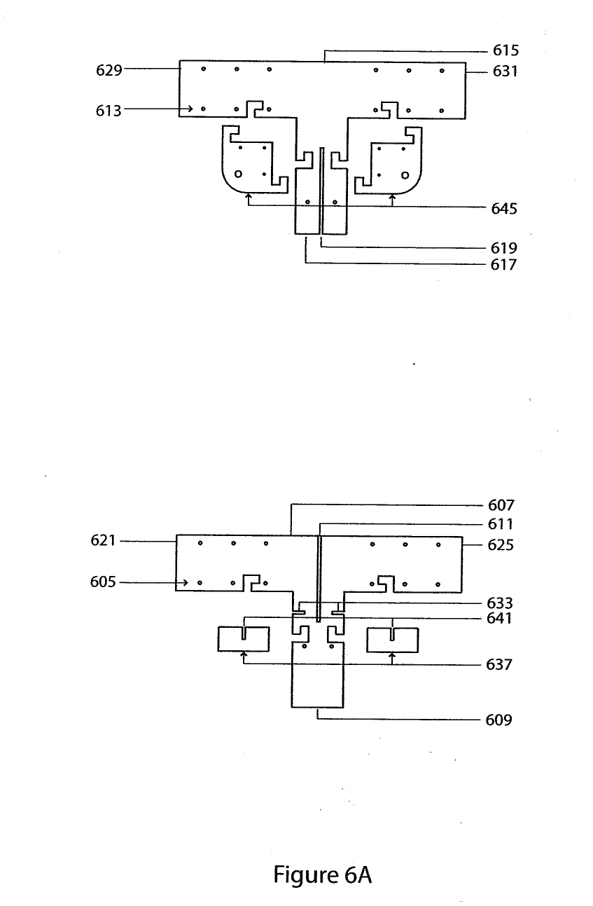

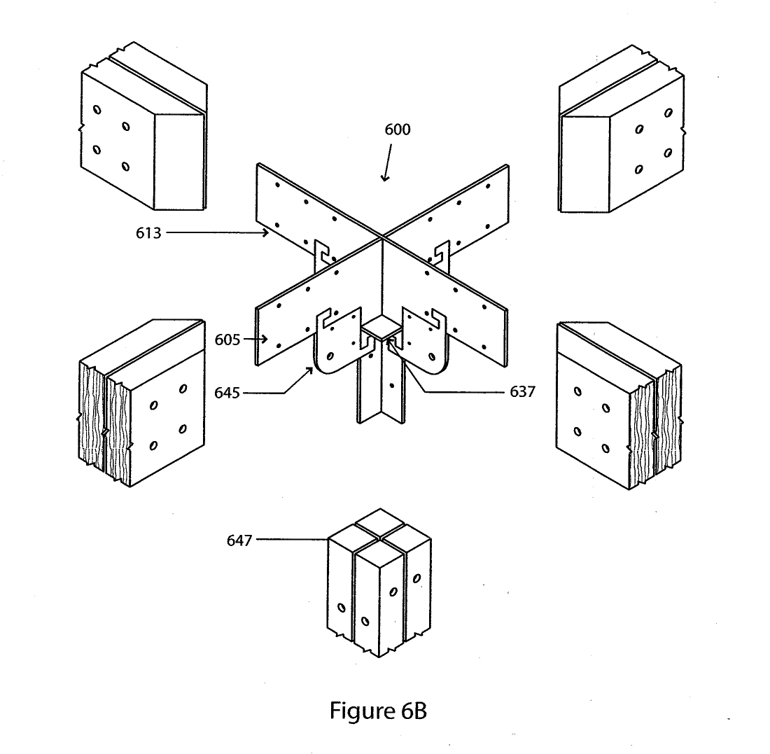

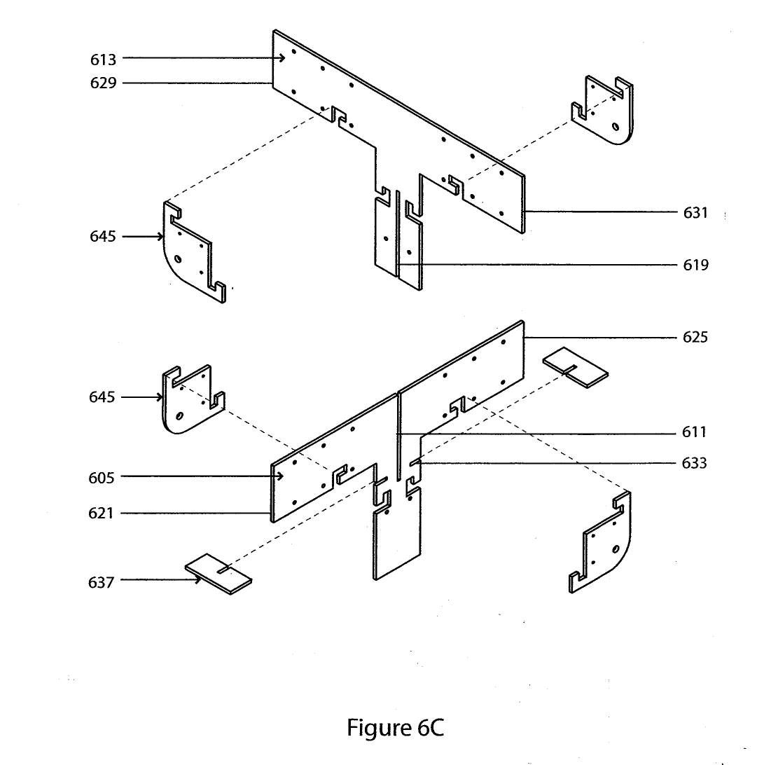

FIGS. 6A, 6B and 6C show an embodiment of the invention as a center connector 600 as would typically be used in the center top position 28 of FIG. 1. The connector 600 generally includes a first plate 605 having respective first 607 and second 609 ends, and a first slit 611 extending from the first end 607 to a predetermined depth on the first plate 605. A second plate 613 is also provided having respective first 615 and second 617 ends, and a second slit 619 extending from the second end 617 of the second plate 613 to a predetermined depth on the second plate 613. For implementation at the center top joint 28, the connector 600 includes a first projecting member 621 extending from one side of the first plate 605 and a second projecting member 625 extending from an opposite side of the first plate 605, such that the first plate 605 generally forms a “T” shape. Similarly, the second plate 613 includes a first projecting member 629 and a second projecting member 631 extending from opposite sides of the second plate 613, to also generally form a “T” shape. In this embodiment, only the first plate 605 includes bearing plate slits 633, for receiving bearing plates 637 therein, since as shown in FIGS. 6b and 6c, a bearing surface is required to only support a post beam 647 on one side. Post beam 647 may be formed in a manner similar to that described in respect of the previous embodiments.

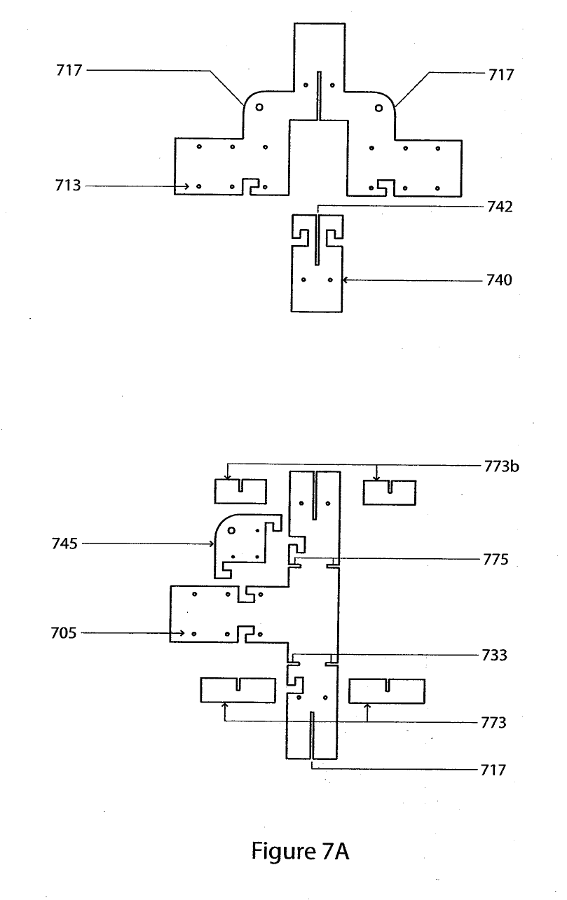

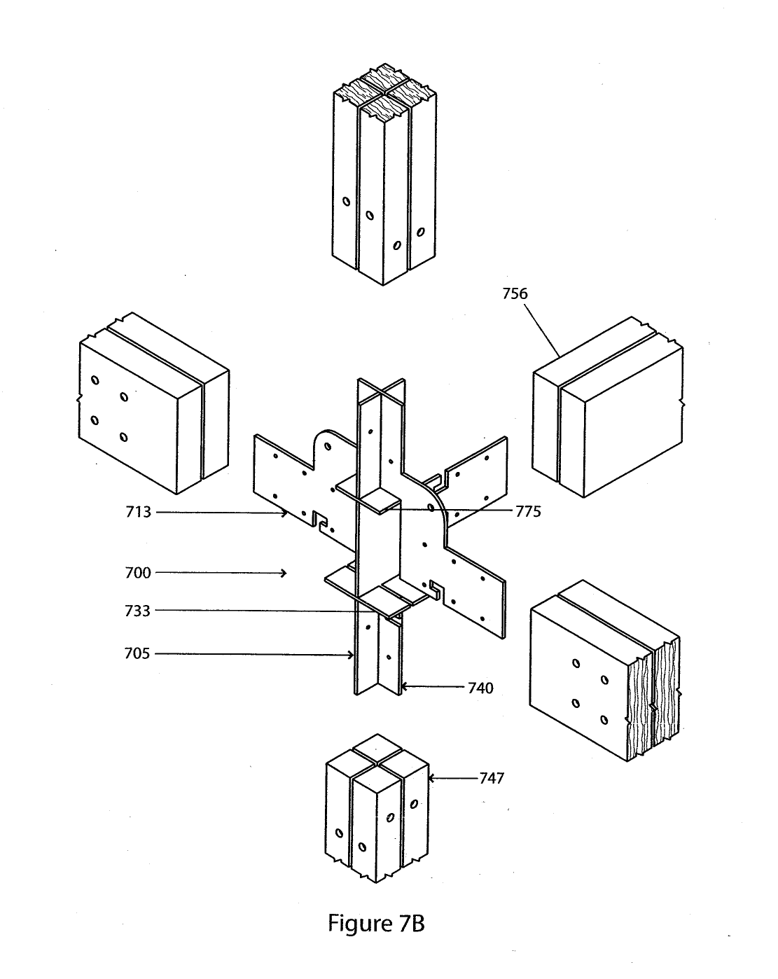

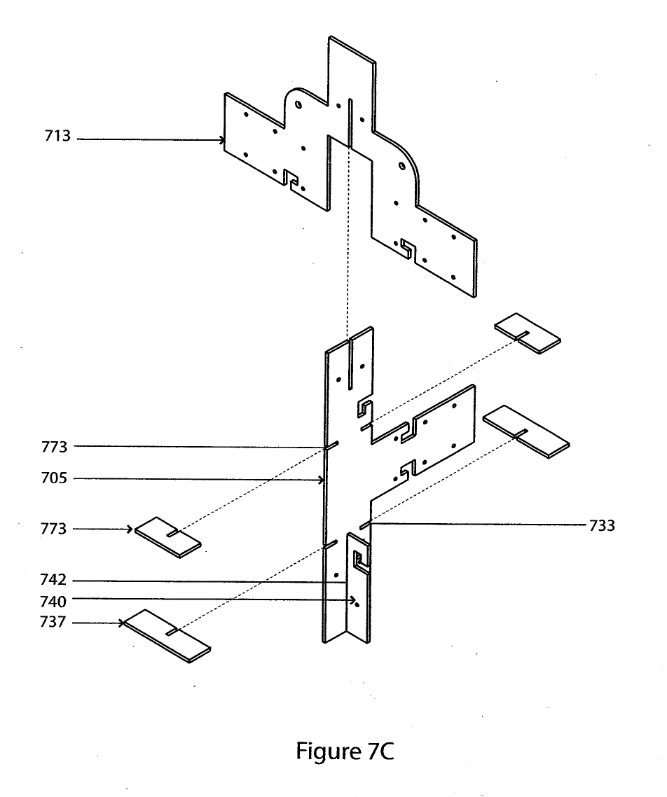

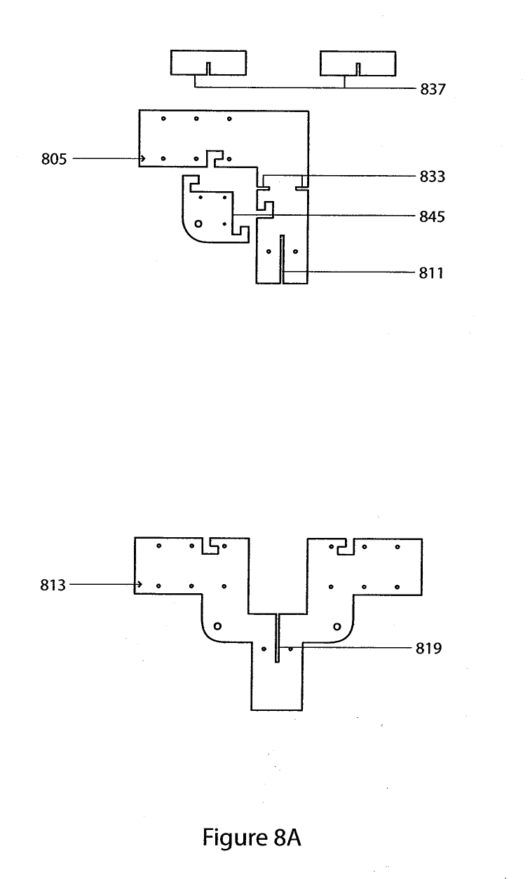

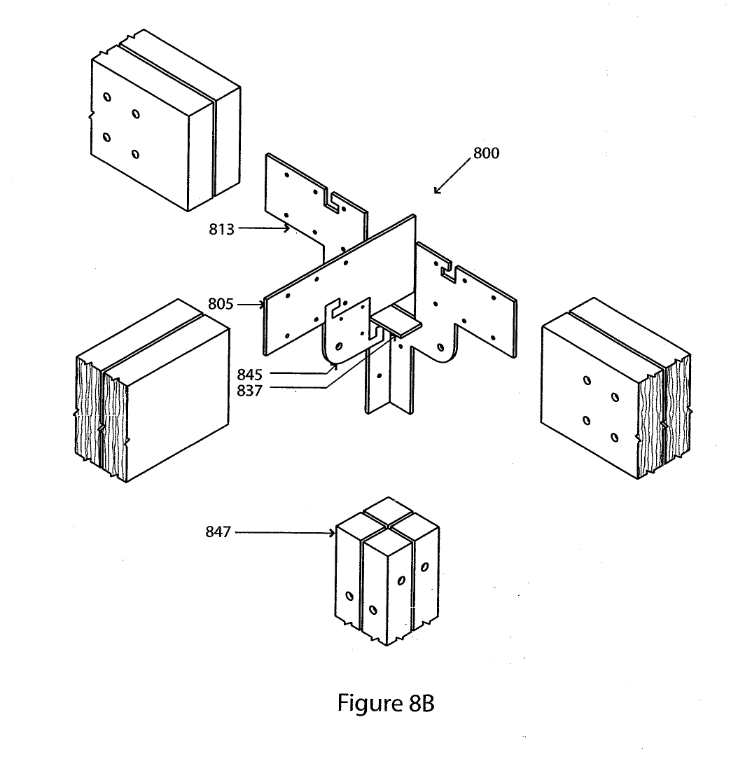

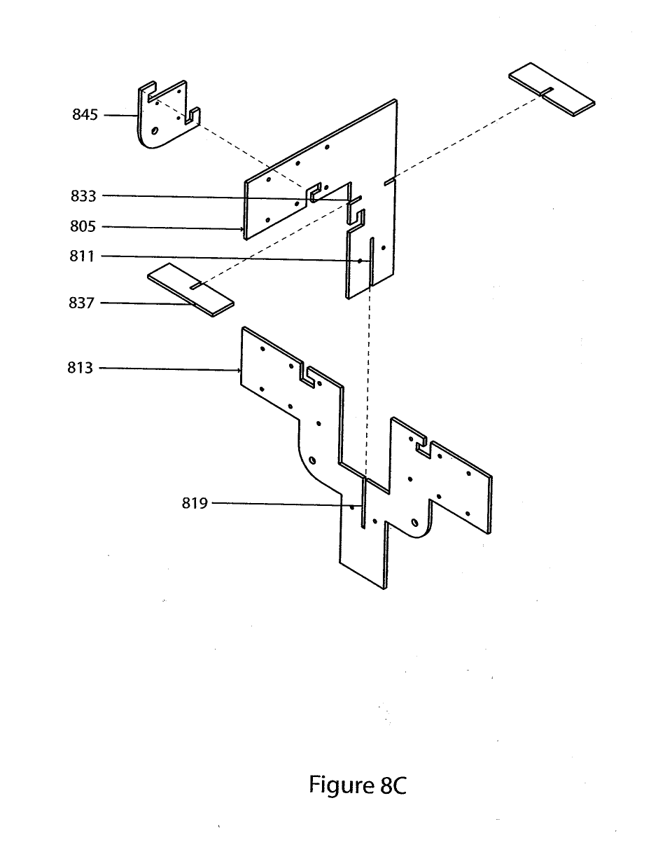

FIGS. 7A, 7B, and 7C show an embodiment of the invention as a cantilever connector 700 as would typically be used as a cantilever joint 14 in FIG. 1. The connector 700 has a first plate similar to that shown in FIG. 4B with respect to the edge connector 400, except that a second bearing plate 773b and bearing plate slit 775, in addition to the bearing plate 737a and slit 733 is provided. The second plate 713 includes integrally formed ear plates 723a for the attachment of cross bracing 24. A third plate 740 is provided to lend additional support and resistance for the cantilevered beam 756. The third plate 740 includes a slit 742 to interact with slit 717 on the first plate 705, as shown in FIG. 7C In use, the third plate 740 is positioned between the post beams 754 to provide additional support for cantilevered beam 756, extending through the joint as shown in FIG. 7B. FIGS. 8A, 8B and 8C show a similar top cantilever connector 800 where the first plate 805 is shaped such that when assembled with the second plate 813 is adapted to support four beams.

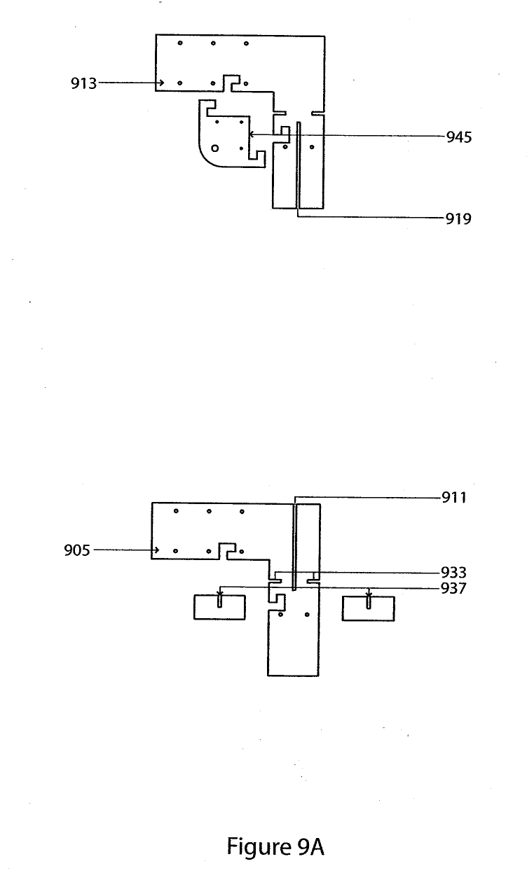

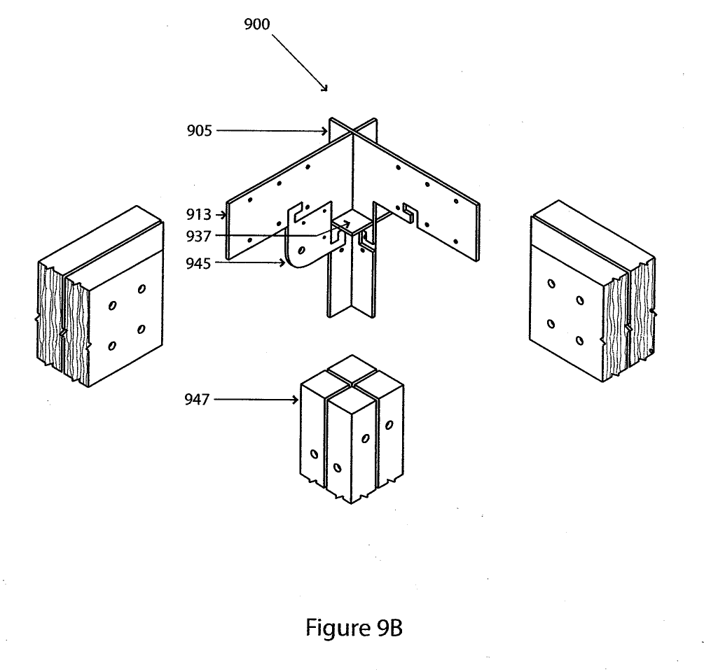

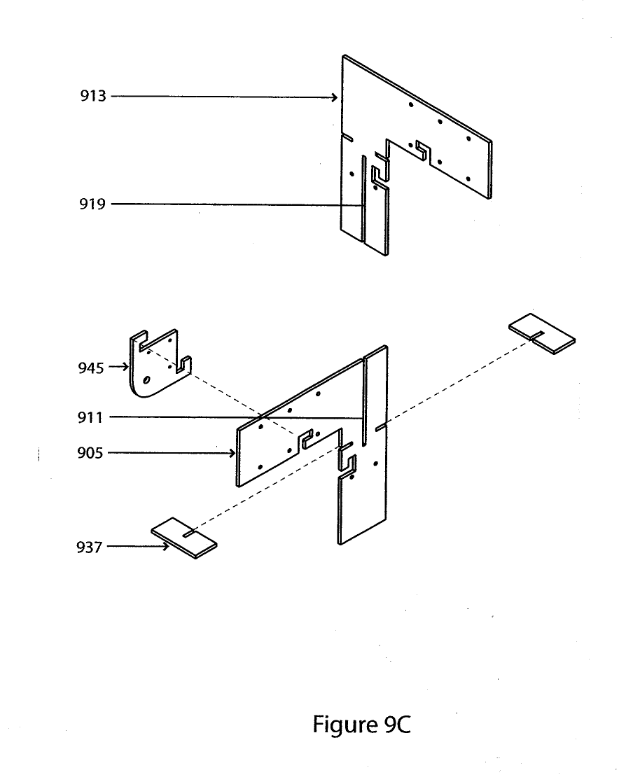

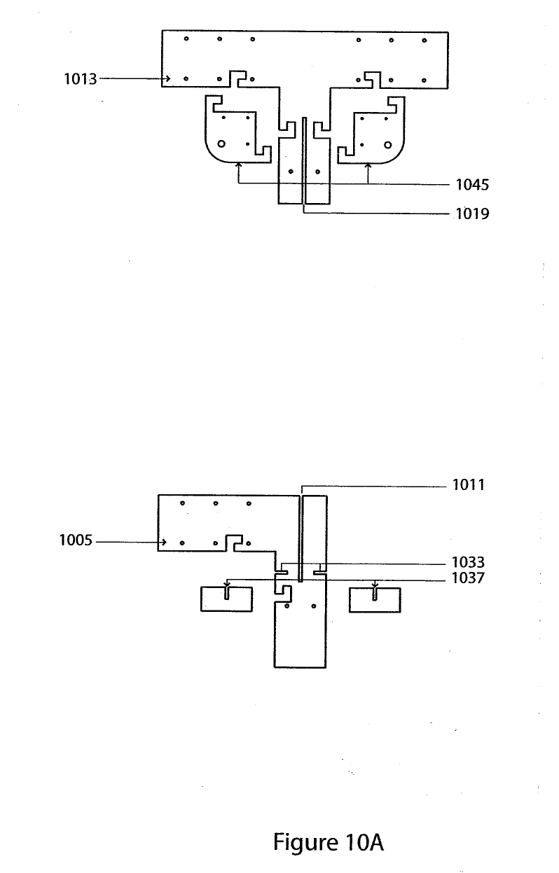

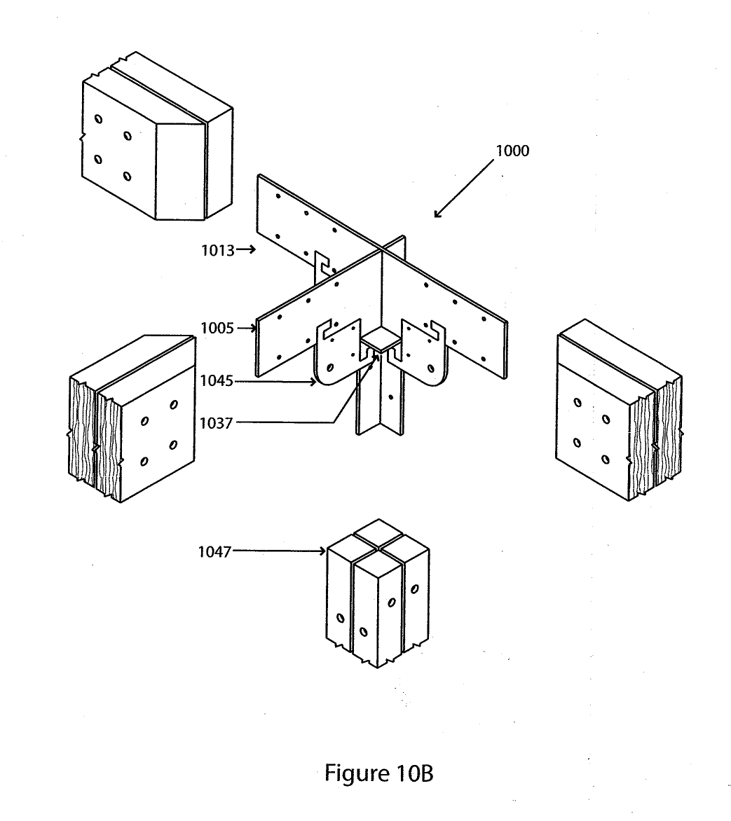

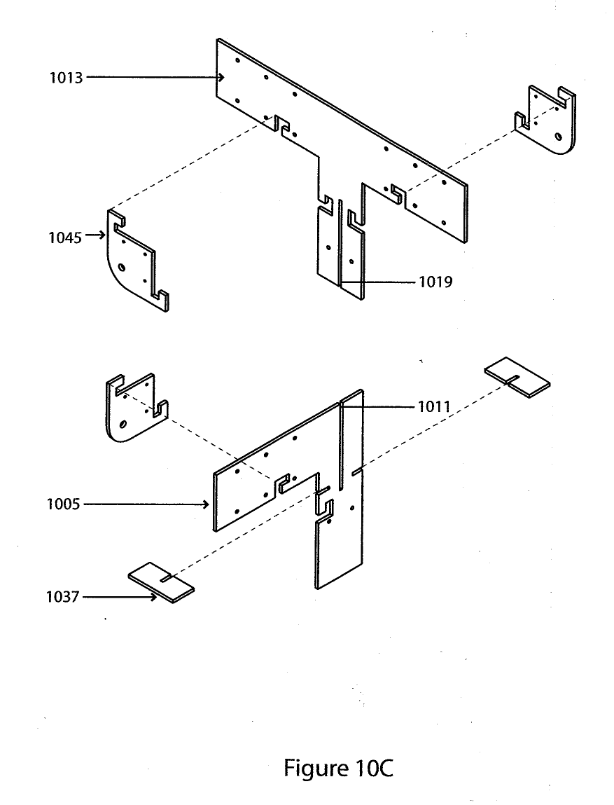

FIGS. 9A, 9B and 9C show an embodiment of the invention as a corner top connector 900 as would typically be used in a corner top joint 30, shown in FIG. 1. The corner top connector 900 includes first 905 and second 913 “L”-shaped plates incorporating the slits 911, 919, bearing plates 937, and ear plate 945 as shown in these figures and previously described. Similarly, FIGS. 10a, 10b and 10c show an edge top connector 1000 having a first plate 1005 and a second plate 1010 as would typically be used in an edge top joint 32, shown in FIG. 1. The first plate 1005 is “L”-shaped, and the second plate 1010 is “T”-shaped, and both incorporate similar slits, 1011, 1019, bearing plates 1037 and ear plates 1045 as previously described.

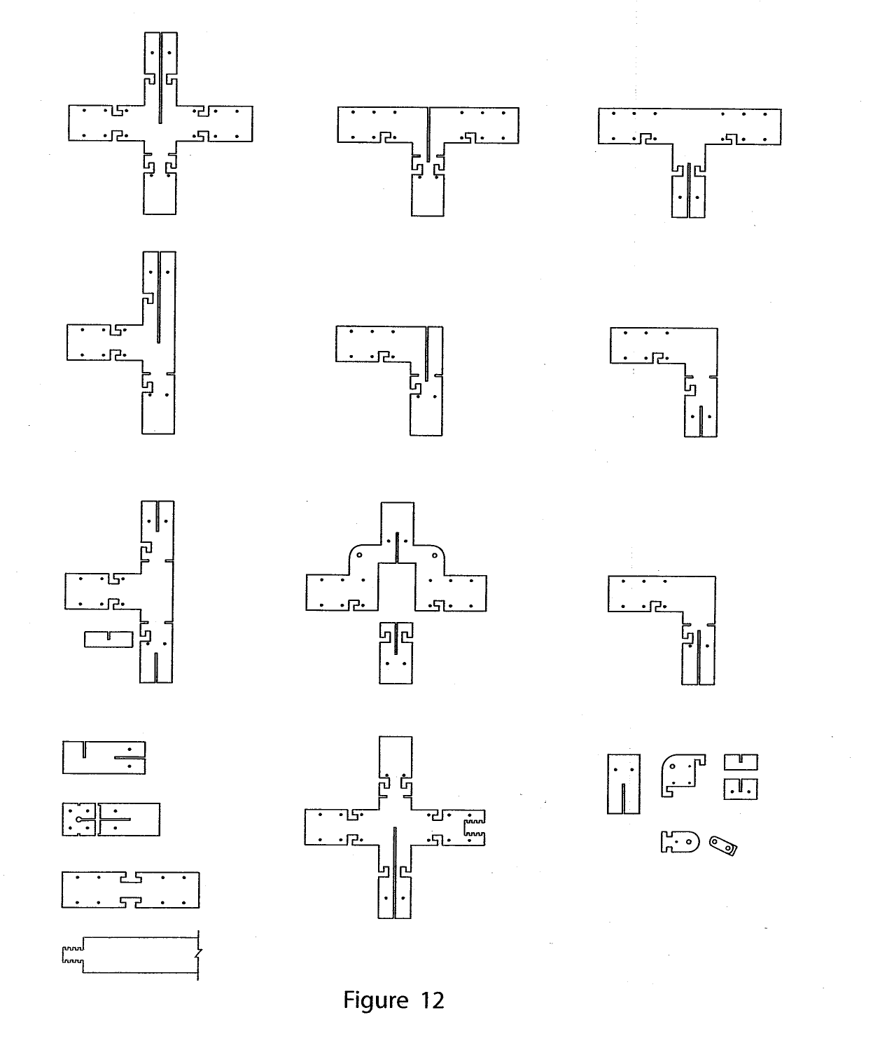

The invention further relates to a kit as shown in FIG. 12 that includes at least one first plate and at least one second plate as described above with respect to the various embodiments of the invention. The plates shown in FIG. 12 are shaped and otherwise dimensioned to interact with each other to form the various joints herein described, and other joints that would be apparent to one skilled in the art. The kit preferably further includes at least one bearing plate and at least one ear plate as herein described.

This concludes the description of a presently preferred embodiment of the invention. The foregoing description has been presented for the purpose of illustration and is not intended to be exhaustive or to limit the invention to the precise form disclosed.

Other modifications and alterations may be used in the design and manufacture of other embodiments according to the present invention without departing from the spirit and scope of the invention, which is limited only by the accompanying claims. For example, the invention may be applied to other materials and types of joint constructions, such as in small scale models of like or varying materials or toy systems formed from plastics materials. Furthermore, it will be understood by one skilled in the art that a connector of the invention may be formed integrally as a single piece, for example by being cast into the disclosed shape.

We claim:

1. A connector for use in a construction joint comprising
a first plate having respective first and second ends, and a first slit extending from said first end to a predetermined depth on said first plate;
a second plate having respective first and second ends, and a second slit extending from said second end of said second plate to a predetermined depth on said second plate;
said first and second plates intersecting through said first and second slits such that the connector has a cross-section that is, at least in part, generally cruciform-shaped.

2. A connector according to claim 1, further comprising
a bearing plate; wherein,
said first plate further includes a bearing plate slit formed between an end of said first slit and said second end of said first plate, and extending generally perpendicular to said first slit; said bearing plate slit receiving said bearing plate therein.
said bearing plate positioned such that said second end of said second plate abuts against said bearing plate.

3. A connector according to claim 2, wherein said first plate further comprises a first projecting member extending from a first side of said first plate.

4. A connector according to claim 3, wherein said first plate further comprises a second projecting member extending from a second side of said first plate.

5. A connector according to claim 2 wherein said bearing plate includes a slit, said slit on the bearing plate adapted to interact with said bearing plate slit on said first plate.

6. A connector according to claim 2, further comprising
a second bearing plate; wherein,
said second plate further includes a second bearing plate slit formed between an end of said second slit and said first end of said second plate, and extending generally perpendicular to said second slit; said second bearing plate slit receiving said second bearing plate therein;
said second bearing plate positioned such that said first end of said first plate abuts against said second bearing plate.

7. A connector according to claim 4, further comprising an ear plate functionally attached to one of said first projecting member and said second projecting member and a portion of said first plate proximate said first slit.

8. A connector according to claim 2, wherein said bearing plate comprises a first bearing plate portion and a second bearing plate portion; said first bearing plate slit comprising two portions extending in part from opposite ends of the first plate to receive therein the said first bearing plate portion and said second bearing plate portion, respectively.

9. A connector according to claim 3, wherein said first projecting member further comprises one of a male or female flitch portion adapted to connect to an adjacent and complimentary flitch portion on a projecting member on an adjacent connector.

10. A method for forming a construction joint comprising:
providing a first plate having respective first and second ends, and a first slit extending from said first end to a predetermined depth on said first plate;
providing a second plate having respective first and second ends, and a second slit extending from said second end of said second plate to a predetermined depth on said second plate;
positioning said first and second plates such that said first and second slits intersect, thereby resulting in a cross-section that is, at least in part, generally cruciform-shaped.

11. A method for forming a construction joint according to claim 10, wherein:
said first plate further includes a bearing plate slit formed between an end of said first slit and said second end of said first plate, and extending generally perpendicular to said first slit; said method further comprising
providing a bearing plate and positioning said bearing plate to be received by said bearing plate slit, wherein said bearing plate is positioned such that said second end of said second plate abuts against said bearing plate.

12. A method for forming a construction joint according to claim 11, wherein said first plate further comprises a first projecting member extending from a first side of said first plate.

13. A method for forming a construction joint according to claim 12, wherein said first plate further comprises a second projecting member extending from a second side of said first plate.

14. A method for forming a construction joint according to claim 11, wherein said bearing plate includes a slit, said slit on the bearing plate adapted to interact with said bearing plate slit on said first plate.

15. A method for forming a construction joint according to claim 11, wherein
said second plate further includes a second bearing plate slit formed between an end of said second slit and said first end of said second plate, and extending generally perpendicular to said second slit; said method further comprising:
providing a second bearing plate and positioning said second bearing plate to be received by said second bearing plate slit, wherein said second bearing plate is positioned such that said first end of said first plate abuts against said second bearing plate.

16. A method for forming a construction joint according to claim 13, further comprising:
providing an ear plate functionally attached to one of said first projecting member and said second projecting member and a portion of said first plate proximate said first slit.

17. A method for forming a construction joint according to claim 11, wherein said bearing plate comprises a first bearing plate portion and a second bearing plate portion; said first bearing plate slit comprising two portions extending in part from opposite ends of the first plate to receive therein the said first bearing plate portion and said second bearing plate portion, respectively.

18. A method for forming a construction joint according to claim 12, wherein said first projecting member further comprises one of a male or female flitch portion adapted to connect to an adjacent and complimentary flitch portion on a projecting member on an adjacent connector.

19. A kit for forming connectors for use in constructions joints comprising:
at least one first plate having respective first and second ends, and a first slit extending from said first end to a predetermined depth on said first plate, said first plate further including a bearing plate slit formed between an end of said first slit and said second end of said first plate, and extending generally perpendicular to said first slit;
at least one second plate having respective first and second ends, and a second slit extending from said second end of said second plate to a predetermined depth on said second plate; and,
at least one bearing plate having a bearing plate slit.

20. A kit according to claim 19 wherein said second plate further comprises a second bearing plate slit formed between an end of said second slit and said first end of said second plate, and extending generally perpendicular to said second slit; said kit further comprising:
at least one second bearing plate having a bearing plate slit;
at least one ear plate having attachment means on adjacent sides thereof.
